(19) United States
(12) Patent Application Publication
(10) Pub. No.: US 2014/0112713 A1
(43) Pub. Date: Apr. 24, 2014

(54) MECHANISMS FOR SECURING A PLURALITY OF COOPERATING COMPONENTS TOGETHER

(71) Applicant: Boston Scientific Scimed, Inc., Maple Grove, MN (US)

(72) Inventor: Scott A. DAVIS, Southborough, MA (US)

(73) Assignee: Boston Scientific Scimed, Inc., Maple Grove, MN (US)

(21) Appl. No.: 14/052,036

(22) Filed: Oct. 11, 2013

Related U.S. Application Data
(60) Provisional application No. 61/717,387, filed on Oct. 23, 2012.

(51) Int. Cl. F16B 17/00

(52) U.S. Cl. CPC F16B 17/00
USPC 403/327; 403/345; 403/364

(57) ABSTRACT

A mechanism for coupling a first structure to a second structure may include a first member and a second member. The first member may include first and second end portions, and the first end portion of the first member may be coupled to the first structure. The second end portion of the first member may include an opening to a cavity extending between the first and the second end portions. The second end portion of the first member may include an engagement member that protrudes into the cavity. The second member also may include a first end portion and a second end portion. The first end portion of the second member may be received into the cavity. The second end portion of the second member may include an engagement structure that cooperates with the engagement member to prevent the movement of the first structure relative to the second structure.

### CROSS-REFERENCE TO RELATED APPLICATIONS

This application claims the benefit of priority from U.S. Provisional Application No. 61/717,387, filed on Oct. 23, 2012, the entirety of which is incorporated by reference herein.

### TECHNICAL FIELD

Embodiments of the present disclosure generally relate to devices used in medical procedures. In particular, embodiments of the present disclosure relate to mechanisms and methods for securing multiple cooperating components of an assembly. The assembly may be a platform for facilitating the operation of one or more medical devices used in, e.g., endoscopic or laparoscopic procedures.

### BACKGROUND

Endoscopy is a form of minimally invasive technique during which suitable introduction sheaths, such as, e.g., endoscopes, and relatively small diameter instruments may be inserted into a patient's body through, e.g., natural body orifices (e.g., mouth or anus) and/or small incisions instead of through large abdominal incisions, which are typically associated with “open” surgeries. A variety of endoscopic systems are available for use in different forms of laparoscopy. In some procedures, especially those utilizing multiple instruments, a stabilizing structure, such as, e.g., a platform, is provided for securing the multiple instruments. The platform, or other suitable stabilizing structure, may hold instruments in place, allowing an operator to use his/her hands for the operation of other instruments.

Such platforms may be secured to an arm assembly, which in turn may be secured adjacent to the patient's position. For example, the arm assembly may be secured to a patient's bed or any other suitable structure. The platform may be adjustable to provide convenient patient access during surgery. In addition, the platform may be removal from the arm assembly to, e.g., facilitate the use of another platform of, e.g., differing size or functionality. Stability is also required, and thus it is also desirable to lock the platform at a specific position relative to the arm assembly, to prevent the platform from changing position during a medical procedure.

Therefore, a need exists for a mechanism that effectively secures a platform, or other suitable stabilizing structure, to an arm assembly, and locks the platform, to prevent the platform's movement with respect to the arm assembly.

### SUMMARY

The present disclosure provides mechanisms and methods for coupling multiple cooperating components of an assembly. The assembly may be a platform for facilitating the operation of one or more devices. The devices may be, e.g., medical devices used in endoscopic or laparoscopic procedures.

In one embodiment, the present disclosure provides a mechanism for coupling a first structure to a second structure. The mechanism may include a first member having a first end portion and a second end portion. The first end portion may be coupled to the first structure, and the second end portion may include an opening to a cavity extending between the first end portion and the second end portion. The second end portion also may include an engagement member that protrudes into the cavity. The mechanism may further include a second member having a first end portion and a second end portion. The first end portion of the second member may be received into the cavity through the opening in the first member. The second end portion of the second member may include an engagement structure that cooperates with the engagement member.

Various embodiments of the mechanism may include one or more of the following features: the second member may be a sphere configured to be received in the cavity of the first member; the engagement structure may include an opening configured to receive a portion of the engagement member; the engagement member may be an engagement pin configured to be received within the engagement structure; the engagement pin may be biased into the cavity by a spring; the first end portion of the second member may be tapered relative a remainder of the second member; the engagement structure includes a plurality of engagement structures; wherein cooperation between engagement member and the opening of the engagement structure prevents the second member from moving relative to the first member in one of the longitudinal and rotational directions; and wherein cooperation between engagement member and the opening of the engagement structure prevents the second member from moving relative to the first member in both of the longitudinal and rotational directions.

In another embodiment, the present disclosure provides a mechanism for coupling a first structure to a second structure. The mechanism may include a first member having a first end portion and a second end portion opposite the first end portion. The first end portion may be configured to be coupled to the first structure. The second end portion may include an opening to a cavity extending between the first end portion and the second end portion. The second end portion also may include an engagement member that protrudes into the cavity. Further, the mechanism may include a second member having a first end portion and a second end portion. The first end portion of the second member may include a substantially spherical configuration, and the first end portion may be configured to be received into the cavity through the opening in the first member. Further, the second end portion of the second member may include an engagement structure for cooperating with the engagement member.

Various embodiments of the mechanism may include one or more of the following features: the engagement member may be a pin configured to be received within the engagement structure; the engagement structure may include a plurality of engagement structures; wherein cooperation between the engagement member and the engagement structure prevents the second member from moving relative to the first member; and wherein the engagement member is configured to protrude into the cavity. In some embodiments, the pin may engage a cavity formed in the surface of the engagement structure. In other embodiments, the pin may extend through the engagement structure from one location to another.

In another embodiment, the present disclosure provides a mechanism for coupling a suitable stabilizing structure to an arm assembly. The stabilizing structure may secure one or more medical devices for performing a medical procedure. The arm assembly may be secured adjacent to a patient's position. The mechanism may include a first member having a first end portion and a second end portion. The first end portion of the first member may be coupled to the stabilizing structure, and the second end portion may have an opening to a cavity extending between the first end portion and the second end portion. The second end portion may include an engagement member that protrudes into the cavity. The mechanism may further include a second member having a first end portion and a second end portion. The first end portion of the second member may be received into the cavity, through the opening in the first member. The second end portion of the second member may also include an engagement structure that cooperates with the engagement member.

Various embodiments of the mechanism may include one or more of the following features: the first end portion of the second member may include a substantially spherical configuration; the engagement structure may include a plurality of engagement structures; the engagement member may be a spring biased engagement pin configured to engage with the engagement structure; wherein cooperation between the engagement member and the engagement structure prevents the second member from moving relative to the first member; and the engagement member is configured to protrude into the cavity

Additional objects and advantages of the present disclosure will be set forth in part in the description, which follows, and in part, will be obvious from the description, or may be learned by practice of the present disclosure. The objects and advantages of the present disclosure will be realized and attained by means of the elements and combinations particularly pointed out in the appended claims.

It is to be understood that both the foregoing general description and the following detailed description are exemplary and explanatory only, and are not restrictive of the invention, as claimed.

### BRIEF DESCRIPTION OF THE DRAWINGS

The accompanying drawings, which are incorporated herein and constitute a part of this specification, illustrate embodiments of the disclosure and in conjunction with the description, serve to explain the principles of the disclosure. Wherever possible, the same reference numbers will be used throughout the drawings to refer to the same or like parts.

FIG. 1 illustrates a mechanism for securing a plurality of cooperating components together, in accordance with the present disclosure.

FIG. 2 illustrates a second member of the mechanism of FIG. 1, according to an embodiment of the present disclosure.

FIG. 3 illustrates the second member of the mechanism of FIG. 1, in accordance with another embodiment of the present disclosure.

FIG. 4 (A) illustrates the mechanism of FIG. 1, when the engagement member is in an unengaged position.

FIG. 4 (B) illustrates the mechanism of FIG. 1, when the engagement member is in an engaged position, engaging with one of the locking features.

### DETAILED DESCRIPTION

Reference will now be made in detail to embodiments of the present disclosure, an example of which is illustrated in the accompanying drawings.

For many endoscopic procedures, the endoscope, or other suitable introduction sheath, serves primarily to provide a means for inserting and employing a variety of minimally invasive tools. These tools are inserted into and through working channels of the endoscope and may be controlled independently of that instrument. In some embodiments, however, control of one or more tools may be integrated with the endoscope. Thus, during medical procedure using independently controlled tools, the endoscope itself should remain stationary. To achieve that result, the endoscope can be mounted on a suitable stabilizing structure, such as, e.g., a platform, which may be positioned next to the patient's bed or chair, or over an operating table, depending on the location of the surgery. The platform may include at least a flat platform portion and an arm connecting the platform to a mounting location, such as an operating table.

Although the present disclosure refers to endoscopic medical procedures, the principles of the present disclosure may be applied to other medical procedures, including, e.g., laparoscopic procedures. Moreover, the principles of the present disclosure may be applied to any technological area where it is desired to secure together two cooperating components of an assembly. The exemplary description herein, therefore, should not be limited to medical technology. Further, although the disclosure herein contemplates a stabilizing structure as a platform, those of ordinary skill in the art will recognize that any suitable stabilizing structure may be used in connection with the principles of the present disclosure. Indeed, in some embodiments, an introduction sheath, endoscope, or other medical device may be directly secured to an arm assembly via the principles disclosed herein.

Just before a surgical procedure is performed, a medical device stabilizing platform may be positioned to provide optimum instrument access to the patient. Specifically, the platform may be fixed in position with respect to the mounting location, such as an operating table by a suitable stabilizing assembly, such as, e.g., an arm assembly. In addition to preventing the platform from becoming disengaged from the arm assembly, it is desired to prevent the platform's movement in one or more degrees of freedom with respect to the arm assembly.

Specifically, in one exemplary embodiment, the present disclosure provides a mechanism interposed between a medical platform and an arm assembly, to prevent movement of the platform with respect to the arm assembly. The mechanism may include a first member adapted to engage with a second member, such that that the first member substantially receives and encompasses the second member when engaged with it. The first member may further include an engagement member disposed at its lower portion, for example. The second member may be sized to be slidingly received in a cavity of the first member, and the second member may further include one or more engagement structures disposed on an outer surface of the second member. When the second member is received within the cavity of the first member, the engagement member of the first member may engage with at least one of the engagement structures associated with the second member. That engagement may prevent relative movement between the first and second members. In one embodiment, the engagement member and structure may cooperate to frictionally prevent, e.g., the rotation of the first member around an axis of the second member and the translation of the first member along a mutual longitudinal axis of the first and second members. Those of ordinary skill will recognize that the features of the first and second members may be interchangeable. For example, the second member may receive the first member, and the second member may include the engagement member while the first member may include the engagement structure.

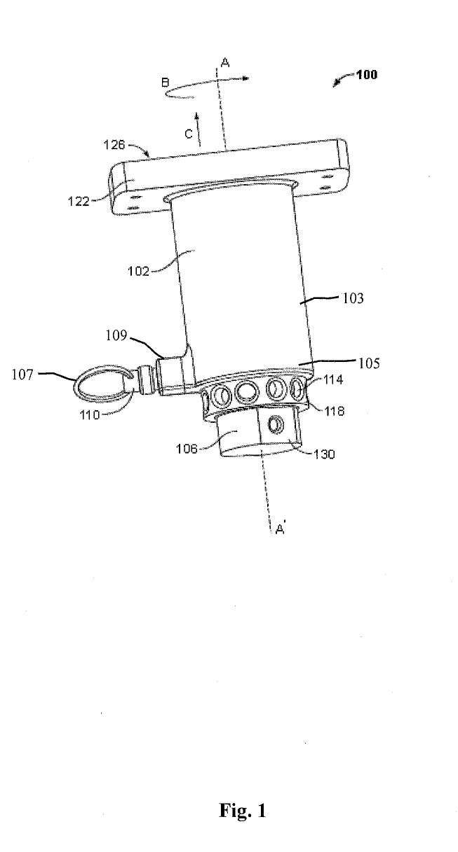

FIG. 1 illustrates a mechanism 100 for securing a stabilizing structure, such as, e.g., a medical device platform with respect to a stabilizing assembly, such as, e.g., an arm assembly, and for preventing the movement of the platform with respect to the arm assembly. Even though the platform and the arm assembly are not shown in the figures, the mechanism 100 is configured to be interposed between the platform and the arm assembly. As shown, the mechanism 100 may include a first member 102 and a second member 106. The configuration depicted in FIG. 1 shows the mechanism 100 in the assembled position. The structure of the different components of the mechanism 100 will be explained in more detail hereinafter, in connection with the subsequent figures. It should be noted that the discussion below employs directional terms “upper” to refer to the end of first member 102 toward an upper portion 122, and “lower” to refer to the end of first member 102 opposite to upper portion 122.

As shown in FIG. 1, the first member 102 may include a substantially planar upper portion 122 and a lower portion 103. The upper portion 122 may be generally flat, adapted to be fastened to a suitable stabilizing structure, such as, e.g., a medical device platform. Any suitable configuration may be used for the upper portion 122, and the depicted embodiment is intended to be exemplary. Here, the attachment of upper portion 122 to a suitable stabilizing structure may be accomplished with screws (not shown) or any conventional fastener, and appropriate holes may be provided within the upper portion 122 for that purpose. Any other suitable attachment means may be used, however. Lower portion 103 may be generally cylindrical. However, any suitable structure or configuration may be used. In the depicted embodiment, lower portion 103 includes a central bore 105. Bore 105 may be substantially cylindrical as well, but may be any suitable configuration. As shown, lower portion 103 may extend substantially perpendicularly away from upper portion 122. However, lower portion 103 may be disposed at any suitable angle relative to upper 103.

In some embodiments, lower portion 103 and upper portion 102 may be fabricated from a one-piece construction. In other embodiments, lower portion 103 and upper portion 102 may be discrete components that are secured to one another by any suitable fastening means.

In accordance with the principles of the present disclosure, lower portion 103 may be provided with a suitable mechanism for securing first member 102 to second member 106. In embodiments where first member 102 does not include a lower portion 103, upper portion 122 may be provided with the suitable mechanism for securing first member 102 to second member 106. For exemplary purposes only, lower portion 103 may include an engagement port 109 located on lower portion 103. Although engagement port 109 may be disposed at a location opposite to upper portion 122, engagement port 109 may be located at any suitable location on lower portion 103. Engagement port 109 may include a cylindrical projection extending radially outward from the lower portion 103. The engagement port 109 may include a spring-loaded, inwardly biased engagement pin 110 sliding in a channel oriented on a radius of the lower member. A manual assist, such as ring 107, may be provided at the outward end of engagement pin 110, to facilitate grasping the pin to pull it outward. Further, in an embodiment, a spring-biased plunger may be used to incorporate the engagement pin 110, and the engagement port 109 may receive the plunger. In some embodiments, engagement pin 110 may be biased into central bore 105. In other embodiments, engagement pin 110 may be configured to be selectively moved into and out of central bore 105.

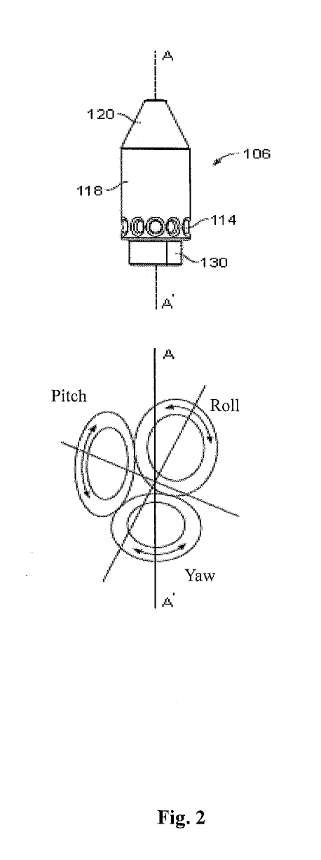

As shown in FIG. 2, the second member 106 may be also substantially cylindrically shaped, sized to fit within the central bore 105 of the first member 102 (shown in FIG. 1). In addition, any suitable configuration capable of being received within bore 105 may be used for second member 106. The upper portion of second member 106 may be tapered to facilitate insertion of second member 106 into central bore 105. A lower end 130 may be configured to be coupled to the arm assembly (not shown), when the mechanism 100 shown in FIG. 1, is interposed between a suitable platform and the arm assembly.

A series of engagement features, such as, e.g., locking holes 114 may be disposed circumferentially around a lower portion 118 of the second member 106. Although the depicted embodiments contemplate the engagement features as locking holes 114, those of ordinary skill in the art will recognize that any suitable engagement features for coupling with engagement pin 110 may be used. Other suitable engagement features may include, e.g., recess, projections, ramps, etc. In addition to or alternatively, the engagement features may include one or more locking grooves extending partially or fully around the perimeter of second member 106. Such grooves would allow rotation between the first member 102 and the second member 106. For example, a vertical groove would allow longitudinal movement but not rotational movement and a horizontal groove would allow rotational movement but not longitudinal movement. It is contemplated, however, that such grooves may extend in any direction to allow and, respectively, prohibit any desired movement between the first member 102 and the second member 106.

Those in the art will understand that the engagement features (e.g., locking hole 114) may also be provided at any other appropriate position on second member 106. The locking holes 114 may be equidistantly positioned around the outer peripheral surface of the member 106, and they may be of uniform depth. However, any suitable spacing between adjacent locking holes 114 may be used. Further, as shown, the locking holes 114 may include a circular cross-section, shaped, and sized to accept a portion of engagement pin 110 (shown in FIG. 1). Openings of a different shape may also be provided as desired, in coordination with the form and shape of the engagement pin 110. It is contemplated that the inner surface of the cavity of first member 102 and/or the outer surface of second member 106 may be roughened or include a sticky or other coating or layer to help secure the two members together. It is also contemplated that an additional sleeve, e.g., a foam or resilient sleeve, or other interfacing element may be disposed between first member 102 and second member 106 to further assist in securing the two members together.

FIG. 1 illustrates the engagement of the first member 102 with the second member 106. When second member 106 enters the central bore 105 of the first member 102, the tapered end of the second member 106 may make contact with the inner end of engagement pin 110 (if engagement pin 110 is biased or otherwise disposed within central bore 105), and forces the pin 110 outward as second member 106 is advanced into central bore 105. When the second member 106 is fully inserted into the central bore 105, the engagement pin 110 may engage one of the locking holes 114. In an embodiment, more than one engagement pins 110 may be provided at the lower portion 103 of the first member 102, or any other suitable portion of the first member 102. In such an embodiment, multiple engagement ports 109 may be provided within the lower portion 103, or any other corresponding suitable portions thereof, and each engagement port may incorporate a specific engagement pin. The different engagement pins 110 may be spring-loaded and biased inwardly towards the central bore 105, and may engage different locking holes 114, to provide added strength and stability to the mechanism 100, in the secured configuration. The engagement pins may, in addition or alternatively, be configured to be manually pushed into a locking hole and locked into place by, for example, a threaded connection. It is also contemplated that the engagement pins may also be deployed by rotational displacement, longitudinal displacement, or a combination thereof. For example, engagement pin 110 may include a threaded connection to first member 102 that maintains the pin out of engagement with locking hole 114, such that when disengaged, e.g., by unthreaded the connection, engagement pin 110 may then be biased into engagement with locking hole 114.

In the illustrated embodiment, seating the engagement pin 110 into a locking hole 114 locks the second member 106 into the first member 102, preventing movement of the first member 102 with respect to the second member 106, along two degrees of freedom. More specifically, as seen in FIG. 1, the first member 102 may be unable to rotate about an axis AA′ of the member 106, along the direction shown by the curved arrow ‘B’. Further, this engagement may also prevent rotation of the first member 102 about the axis AA′, in the opposite sense (i.e., clockwise rotation, as seen from the top). Another degree of freedom is the translational movement along the axis AA′, i.e., the longitudinal axis, as shown. If not so restrained, the first member 102 may inadvertently slide upwards, with respect to the second member 106. However, with the engagement pin 110 engaged with a locking hole 114, the mechanism 100 prevents the translation of the member 102 along the axis AA′ of the second member 106, along the upward direction as represented by arrow C′.

As noted above, the first member 102 has an extended flat portion 122 (i.e., the flange) (referred to as ‘portion 122’) attached to its upper portion. The top surface 126 of the portion 122 may serve as a mounting surface for a suitable stabilizing structure such as, e.g., a medical device platform. The platform may be securely positioned and mounted over the top surface 126 by any suitable means. Further, the lowermost end 130 of the second member 106 may serve to couple the mechanism 100 to suitable arm assembly (not shown).

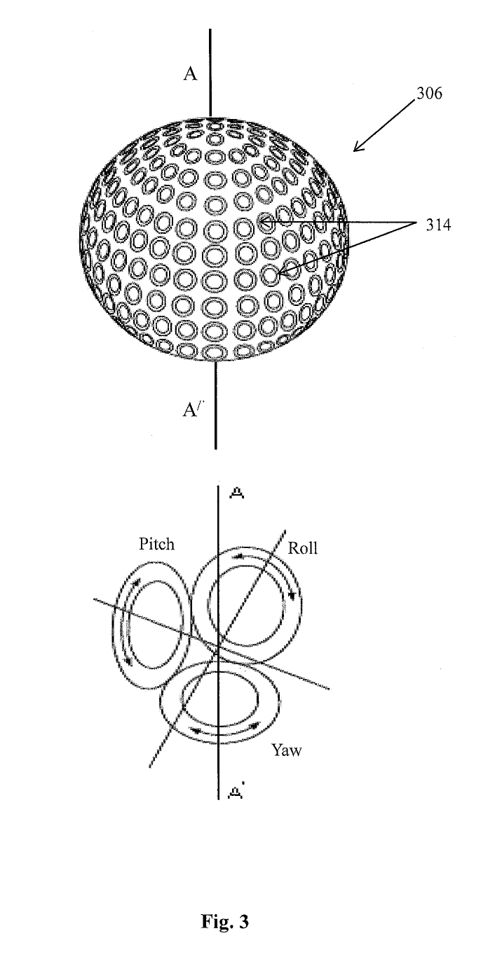

In another embodiment of the present disclosure, the second member may be substantially spherically shaped, as shown in FIG. 3. The second member 306, which may be configured to serve the same functionality as that of the member 106 of FIG. 1, may include multiple engagement structures such as, e.g., locking holes 314, provided uniformly over its outer surface. These locking holes 314 may be adapted to receive the engagement pin 110 (shown in FIG. 1). Further, the engagement pin 110 can engage at least one of the locking holes 314, to facilitate easy adjustment of the first member 102, with respect to the second member 306, in a desired position. In an embodiment, more than one engagement pin 110 may be used, and each one of those engagement pin 110 may be configured to engage one of the locking holes 314. Multiple engagement pins may be used to provide additional strength in terms of securing the first member 102 with respect to the second member 106, and to increase the stability of the mechanism 100 of the present disclosure, when the mechanism 100 is in the secured configuration. In the illustrated embodiment, the mechanism prevents the movement of the first member 102 with respect to the second member 306, along three different degrees of freedom, as the first member 102 engages with the second member 306. Specifically, the first member 102 is restricted to pitch, roll, or yaw with respect to the second member 306. Moreover, the first member 102 may inadvertently pull off, and slide upwards, by translating along the axis AA′ of the second member 306. However, with the engagement pin 110 engaging with one or more of the locking holes 314, the first member 102 is prevented from translating upwards, along the axis AA′. In the illustrated embodiment, the first member 102 has an appropriate compatible shape, to immovably engage with the second member 306. Those in art will understand that the first member 102 can be a spherically shaped sphere of a radius larger than that of the second member 306, to substantially encompass the second member 306, while engaging with it. Further, first member 102 can also be a cylindrically shaped flange, as shown previously in FIG. 1.

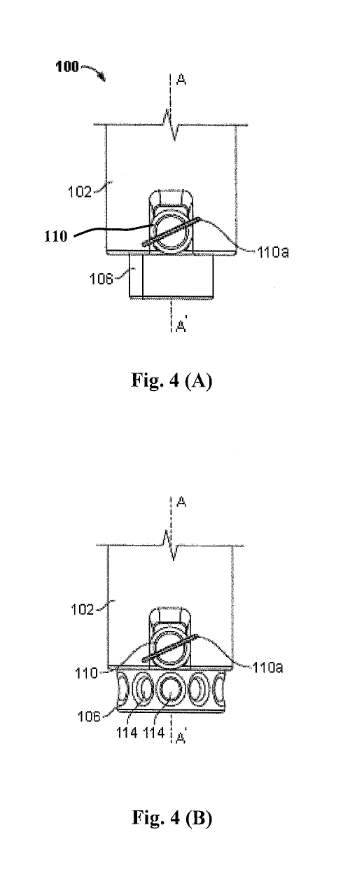

FIG. 4 (A) shows the first member 102 receiving the second member 106 partially, with the engagement pin 110 still unengaged with any of the locking holes 114. In the illustrated configuration, the first member 102 is freely movable, and it can both rotate and translate about the longitudinal axis AA′ of the second member 106. Effectively, when the mechanism 100 is in the illustrated configuration, a suitable platform (mountable over the member 102) is still free to rotate and translate with respect to an arm assembly or other supporting structure (not shown). Before constraining the movement of the platform with respect to the arm assembly, the platform may be adjusted and positioned at a desired configuration, with respect to the arm assembly. To adjust the platform, the first member 102 may be rotated with respect to the second member 106, and positioned in alignment with one of the locking holes 114. This adjustment is based on a specific position of the platform, with respect to the arm assembly, desired for performing the medical procedure. Thereafter, the first member 102 may be moved slightly downwards, to bring the engagement pin 110 in accurate horizontal alignment with a specific locking hole 114. The engagement pin 110 may be spring-biased, and by virtue of the spring's restoring force, it protrudes into the specific locking hole 114 and engages therewith, thus preventing the movement of the first member 102 with respect to the second member 106.

FIG. 4 (B) shows the mechanism 100 in the configuration when the first member 102 immovably engages with the second member 106, and the engagement pin 110 has engaged with at least one of the locking holes 114. As shown, the component 110(a) of the engagement pin 110, is in the activated state. The engagement pin 110 engages with at least one of the locking holes 114, and the locking holes 114 may be completely hidden, as the first member 102 substantially receives the second member 106. In this state, the first member 102 becomes immovable with respect to the second member 106, and cannot either rotate about, or translate along the longitudinal axis AA′.

Although the current disclosure has been described comprehensively, in considerable details to cover the possible aspects and embodiments, those skilled in the art will understand that other versions of the disclosed embodiments may also be possible. Additional embodiments of the present disclosure will be apparent to those skilled in the art from consideration of the specification and practice of the embodiments disclosed herein. Further, the illustrative embodiments, as disclosed herein, should be considered as exemplary only, and are not intended to define or limit the scope of the described embodiments. The true scope and spirit of the invention is indicated by the following claims.

What is claimed is:

1. A mechanism for coupling a first structure to a second structure, comprising:
a first member having a first end portion for coupling to the first structure and a second end portion opposite the first end portion, wherein the second end portion includes an opening to a cavity disposed between the first and second end portions, and wherein the second end portion includes an engagement member configured to protrude into the cavity; and
a second member having a first end portion and a second end portion, wherein the first end portion of the second member is configured to be received into the cavity through the opening in the first member, and wherein the second end portion of the second member includes an engagement structure for cooperating with the engagement member;
wherein the second member is positionable relative to the first member in a plurality of positions; and
wherein the engagement structure cooperates with the engagement member in each of the plurality of positions.

2. The mechanism of claim 1, wherein the second member is a sphere configured to be received in the cavity of the first member.

3. The mechanism of claim 1, wherein the engagement structure includes an opening configured to receive a portion of the engagement member.

4. The mechanism of claim 1, wherein the engagement member is an engagement pin configured to be received within the engagement structure.

5. The mechanism of claim 4, wherein the engagement pin is biased into the cavity by a spring.

6. The mechanism of claim 5, wherein the first end portion of the second member is tapered relative a remainder of the second member.

7. The mechanism of claim 1, wherein the engagement structure includes a plurality of engagement structures.

8. The mechanism of claim 3, wherein cooperation between engagement member and the opening of the engagement structure prevents the second member from moving relative to the first member in one of the longitudinal and rotational directions.

9. The mechanism of claim 8, wherein cooperation between engagement member and the opening of the engagement structure prevents the second member from moving relative to the first member in both of the longitudinal and rotational directions.

10. A mechanism for coupling a first structure to a second structure, comprising:
a first member having a first end portion for coupling to the first structure and a second end portion opposite the first end portion, wherein the second end portion includes an opening to a cavity disposed between the first and second end portions, and wherein the second end portion includes an engagement member; and
a second member having a first end portion and a second end portion, wherein the first end portion of the second member includes a substantially spherical configuration, wherein the first end portion is configured to be received into the cavity through the opening in the first member, and wherein the second end portion of the second member includes an engagement structure for cooperating with the engagement member.

11. The mechanism of claim 10, wherein the engagement member is a pin configured to be received within the engagement structure.

12. The mechanism of claim 10, wherein the engagement structure includes a plurality of engagement structures.

13. The mechanism of claim 10, wherein cooperation between the engagement member and the engagement structure prevents the second member from moving relative to the first member.

14. The mechanism of claim 10, wherein the engagement member is configured to protrude into the cavity.

15. A mechanism for coupling a suitable stabilizing structure to an arm assembly, the stabilizing structure being configured to secure one or more medical devices for performing a medical procedure, and the arm assembly being secured adjacent to a patient's position, the mechanism comprising:
a first member having a first end portion for coupling to the stabilizing structure and a second end portion opposite the first end portion, wherein the second end portion includes an opening to a cavity disposed between the first and second end portions, and wherein the second end portion includes an engagement member; and
a second member having a first end portion and a second end portion, wherein the first end portion of the second member is configured to be received into the cavity through the opening in the first member, and wherein the second end portion of the second member includes an engagement structure for cooperating with the engagement member.

16. The mechanism of claim 15, wherein the first end portion of the second member includes a substantially spherical configuration.

17. The mechanism of claim 15, wherein the engagement structure includes a plurality of engagement structures.

18. The mechanism of claim 15, wherein the engagement member is a spring biased engagement pin configured to engage with the engagement structure.

19. The mechanism of claim 15, wherein cooperation between the engagement member and the engagement structure prevents the second member from moving relative to the first member.

20. The mechanism of claim 15, wherein the engagement member is configured to protrude into the cavity.
